(19) United States
(12) Patent Application Publication
(10) Pub. No.: US 2024/0212466 A1
(43) Pub. Date: Jun. 27, 2024

(54) RESIDENTIAL ALARM SYSTEM AND METHOD

(71) Applicant: Bruce Allan Fraser, Surrey (CA)

(72) Inventor: Bruce Allan Fraser, Surrey (CA)

(21) Appl. No.: 18/145,056

(22) Filed: Dec. 22, 2022

(51) Int. Cl. G08B 13/196; G06V 40/16; G08B 25/10

(52) U.S. Cl. CPC G08B 13/196; G06V 40/161; G08B 25/10

(57) ABSTRACT

A residential alarm system and method that is installed in a user's home to provide monitoring of the environment and further provide audio and visual alerts to others within a geographic proximity. The present invention includes a control module that provides functional operation of all features. Operably coupled to the control module are an warning module, at least one camera module, at least one personal fob, a transceiver and a database. A user of the present invention utilizes the personal fob to activate the alarm in the event of a need or emergency. The control module can further provide notification to alternate parties via SMS text or other techniques. The present invention includes a camera module continuously capturing video data and transmitting to a database. Facial imagery captured by the camera module is cross-reference to a facial imagery in the database to monitor for restricted individuals.

### FIELD OF THE INVENTION

The present invention relates generally to residential security systems, more specifically but not by way of limitation, a no-fee security system that includes personal fobs to initiate an alert as well as cameras to automatically identify restricted individuals.

### BACKGROUND

Crime rates affect a good portion of our everyday lives and influences our economic and lifestyle decisions which underlies some of the decisions individuals will make regarding certain areas of their lives. One area that individuals are concerned with is personal security and security for their families. Burglaries accounted for approximately seventeen percent of committed property crimes. The data for recent years show that there were approximately seven million property crimes which includes categories such as but not limited to burglaries, larceny-thefts, and motor vehicle thefts. The crime data further indicates that nearly two-thirds of the total number of burglaries were home invasion burglaries. Of these, almost half were committed by forcible entry and another third were unlawful entries.

Additional data indicates that there were approximately two and a half residential trespasses and burglaries committed in the United States on an annual basis. There were also around fourteen million property victimizations in US households. The annual rate of property victimization is estimated at 108.2 per 1,000 households. Included within the aforementioned data are perpetrators that have a restraining order against them but forcibly or unlawfully trespassed onto a property or entered into a residence. Restraining orders is the United States total about 7.7 per 1000 people and are issued in order to establish a boundary between individuals wherein one individual could potentially be harmed. While security systems do off some protection, most charge a fee which can be prohibitive. Further, no security system assists in identification of restricted individuals in an automated manner.

It is intended within the scope of the present invention to provide a no-fee security system that includes a plurality of personal fobs operable to initiate an alarm and further includes cameras communicably coupled to a database for utilization in identification of restricted individuals.

### SUMMARY OF THE INVENTION

It is the object of the present invention to provide a security system that produces and alarm utilizing a first method and a second method wherein the security system is configured to be installed in a residential home or similar structure.

Another object of the present invention is to provide a no service fee alarm system that provides alerts to potential intruders or is activated by a user in an emergency wherein in the first method of the present invention the user activates an alarm with a personal fob.

A further object of the present invention is to provide a security system that produces and alarm utilizing a first method and a second method wherein in the second method the present invention broadcasts an alarm based on video recognition of a restricted person.

Still another object of the present invention is to provide a no service fee alarm system that provides alerts to potential intruders or is activated by a user in an emergency wherein the present invention includes a plurality of cameras.

An additional object of the present invention is to provide a security system that produces and alarm utilizing a first method and a second method wherein the alarm system produces both visual and audio warnings.

Yet a further object of the present invention is to provide a no service fee alarm system that provides alerts to potential intruders or is activated by a user in an emergency wherein system is further configured to transmit an emergency call to various entities.

Another object of the present invention is to provide a security system that produces and alarm utilizing a first method and a second method wherein the present invention is further operable to provide notification to individuals within a geographic proximity ensuing activation of the alarm.

An alternate object of the present invention is to provide a no service fee alarm system that provides alerts to potential intruders or is activated by a user in an emergency wherein the video data collected by the cameras is cross referenced in real time to a database of restricted individuals.

Still a further object of the present invention is to provide a security system that produces and alarm utilizing a first method and a second method wherein in a preferred embodiment of the present invention the present invention is powered by battery power.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a block diagram of the components of the present invention; and

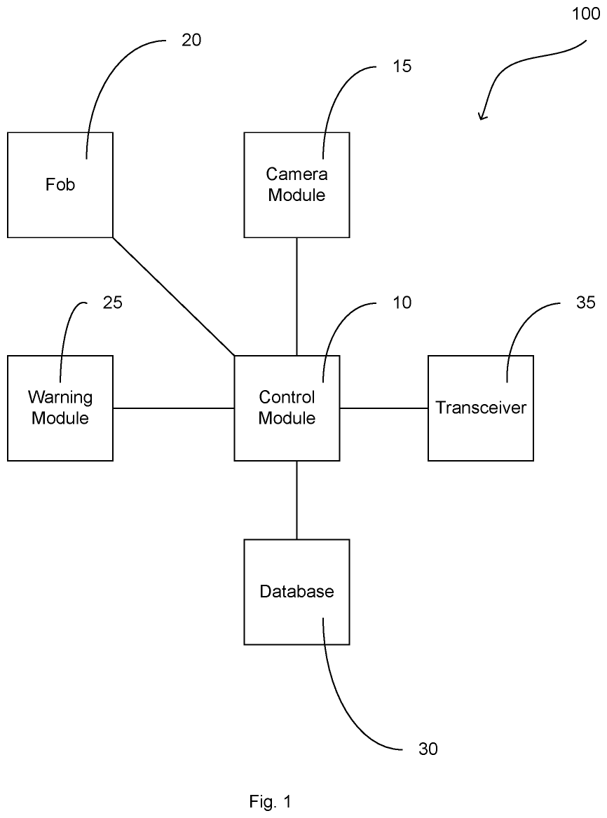

FIG. 2 is a flow chart of the method of operations of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a residential alarm system and method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring to the drawings submitted herewith, the residential alarm system and method 100 includes a control module 10 wherein the control module 10 is a conventional computing module having the necessary electronics to receive, store, transmit and manipulate data. The control module 10 controls all functions of the residential alarm system and method 100 and resides in the structure in which the residential alarm system and method 100 is installed. Operably coupled to the control module is the transceiver module 35. As is further discussed herein, the transceiver module 35 transmits a signal to programmed third parties in the event an alarm is activated. The residential alarm system and method 100 includes at least one warning module 25. The warning module 25 is operably coupled to the control module 10 and provides both an audio alert and a visual alert subsequent activation of the alarm. It should be understood within the scope of the present invention that the warning module 25 could be mounted either inside and/or outside the structure in which the residential alarm system and method 100 is installed. It is further contemplated within the scope of the present invention that the residential alarm system and method 100 could employ several warning modules 25 mounted in alternate locations.

The residential alarm system and method 100 includes a plurality of personal fobs 20 that are operably coupled to the control module 10 utilizing suitable wireless communications. The personal fobs 20 are configured with a conventional transceiver that is operable to transmit and receive a signal to and from the control module 10. A user of the residential alarm system and method 100 employs the personal fob to activate the warning module 25 in the event of an emergency. The residential alarm system and method 100 includes a plurality of camera modules 15 to capture live video data and transmit the video data to the control module 10 for subsequent transmission to the database 30. The camera modules 15 are conventional high-resolution cameras capable of capturing video data in full light and low light conditions. In a preferred embodiment of the present invention the camera modules 15 are deployed both inside and outside the structure in which the residential alarm system and method 100 is installed. As is further discussed herein, the video data from the camera modules 15 is cross-referenced in real-time with the database 30 to actively monitor for any individual that is restricted from being near or within the structure in which the residential alarm system and method 100 is mounted.

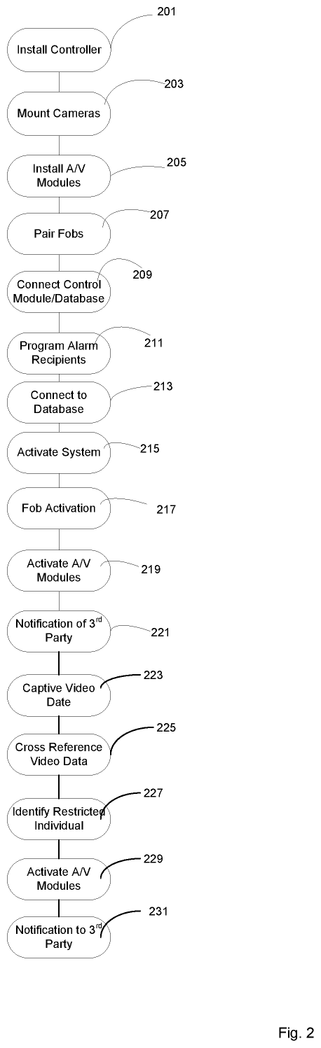

Now referring to FIG. 2 submitted as a part hereof, the method of the residential alarm system and method 100 is diagrammed therein. In step 201, a user will install the control module 10 in a desired location and communicably couple the control module 10 to the Internet utilizing suitable communications protocols. Step 203, the user will mount the camera modules 15 in the desired locations. It should be understood within the scope of the present invention that the present invention could deploy various quantities of camera modules 15. The camera modules 15 are communicably coupled to the control module 10 utilizing suitable wireless communication protocols. In step 205, the user will mount the warning module 25 in a desired location. It is contemplated within the scope of the present invention that the warning module 25 could be separated to independently provide audio and visual functions. Additionally, it is contemplated within the scope of the present invention that the warning module 25 could be mounted outside of the structure in which the present invention is installed so as to provide alert to those nearby.

In step 207, the user will communicably pair the personal fobs 20 with the control module 10. It should be understood within the scope of the present invention that the residential alarm system and method 100 can be deployed with alternate quantities of personal fobs 20. The personal fobs 20 can be programmed specifically to each individual utilizing the present invention wherein upon activation thereof different third parties are transmitted a notification of activation for each programmed personal fob 20. In step 209, the control module 10 is operably coupled to the database 30. The database 30 of the present invention can be provided by local authorities or can be populated by the user of the residential alarm system and method 100. The database 30 is populated with facial image data of restricted individuals so as to be compared to video data captured by the camera module 15 as is further discussed herein.

Step 211, the user will program the control module 10 with contact information of individuals to receive a signal upon the residential alarm system and method 100 being activated. The transceiver 35 provides notifications to the programmed individuals ensuing activation of the alarm of the present invention. It should be understood that the notification transmitted by the transceiver 35 could be but is not limited to a phone call, SMS text or email. In step 213, the user will upload any facial image data of individuals that will be monitored for by the camera modules. Step 215, the user will activate the present invention so as to commence operation thereof. In step 217, a user will engage the personal fob 20 to activate the present invention due to an emergency. Step 219, ensuing detection of activation by the personal fob 20, the control module 10 will activate the warning module 25 providing both sound and light alerts. In step 221, if programmed, the control module 10 will employ the transceiver 35 to transmit a notification to third parties not located within the structure that an emergency is occurring.

In step 223, the camera modules 15 are continuously capturing data. It should be understood that the process flow herein is exemplary and that the order to operations can include continual operations of some of the features as in step 223 through 227 and is not to be interpreted as a discrete step occurring in a particular order. Step 225, the captured video data is transmitted to the database 30 wherein the database utilizes facial recognition technology to compare facial images within the captured video data against facial images of restricted individuals. It should be understood that the user can program the restricted individuals facial image data or be obtained from other sources such as but not limited to law enforcement. In step 227, a facial image captured by the camera module 15 is determined to match a facial image in the database 30. Step 229, the control module 10 will receive notification from the database 30 that a facial image match has occurred and as such the control module 10 will activate the warning module 25. In step 231, it is further contemplated within the scope of the present invention that the control module 10 could initiate contact of third parties via the transceiver 35 upon a facial image data match.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A residential security system and method configured to provide security at a place of residence wherein the method comprises the steps of:
installing a control module, said control module having necessary electronics to store, receive, transmit and manipulate data, said control module providing operation of the residential security system;
mounting at least one camera, said at least one camera being mounted at the place of residence, said at least one camera being communicably coupled to said control module;
installing at least one warning module, said at least one warning module be operably coupled to said control module, said at least one warning module configured to provide both audio and visual alerts;
pairing at least one personal fob, wherein the at least one personal fob is communicably coupled to said control module utilizing wireless communications, said at least one personal fob configured to activate the security system on demand;
connecting said control module to a database, said database being remotely located from said control module, said database having facial imagery data;
activating the residential security system, wherein a user activates the residential security system to monitor a residence;
activating an alarm via the personal fob, wherein the user engages the personal fob to activate the warning module;
notifying a third party, wherein ensuing the activation of the alarm the control module utilizes a transceiver to transmit a signal to the third party;
capturing video data, wherein the at least one camera provides continuous capture of video data and transfers said video data to said control module; and
wherein said video data includes facial imagery of individuals within range of the at least one camera.

2. The residential security system and method configured to provide security at a place of residence as recited in claim 1, and further including a step of programming recipients to be notified subsequent alarm activation, wherein the user programs contact information for individuals to be contacted by the security system ensuing alarm activation.

3. The residential security system and method configured to provide security at a place of residence as recited in claim 2, and further including a step of activating the warning module, wherein the warning modules are activated to produce a visual warning and an audio warning.

4. The residential security system and method configured to provide security at a place of residence as recited in claim 3, and further including a step of cross-referencing the video data to the facial imagery on said database.

5. The residential security system and method configured to provide security at a place of residence as recited in claim 4, and further including a step of identifying a restricted individual, wherein a software application on the database identifies a match of facial imagery between the video data and a restricted individual stored on the database.

6. The residential security system and method configured to provide security at a place of residence as recited in claim 5, and further including a step of activating the warning module, wherein said control module activates the warning module ensuing notification from said database regarding a facial imagery match.

7. The residential security system and method configured to provide security at a place of residence as recited in claim 6, and further including a step of programming the database, wherein the user uploads facial imagery data of individuals whom are not permitted at the place of residence.

8. The residential security system and method configured to provide security at a place of residence as recited in claim 7, wherein said at least one warning module is installed both inside the place of residence and outside the place of residence.
